(19) United States
(12) Patent Application Publication
(10) Pub. No.: US 2014/0274408 A1
(43) Pub. Date: Sep. 18, 2014

(54) METHODS AND SYSTEMS FOR PROVISIONING A GAME CONTAINER WITHIN A CLOUD COMPUTING SYSTEM

(71) Applicant: Zynga Inc., San Francisco, CA (US)

(72) Inventor: Lokesh M. Dave, Sammamish, WA (US)

(73) Assignee: Zynga Inc., San Francisco, CA (US)

(21) Appl. No.: 14/204,234

(22) Filed: Mar. 11, 2014

Related U.S. Application Data
(60) Provisional application No. 61/784,585, filed on Mar. 14, 2013.

(51) Int. Cl. A63F 13/30

(52) U.S. Cl. CPC A63F 13/12
USPC 463/42

(57) ABSTRACT

A system, a computer readable storage medium storing at least one program, and a computer-implemented method for provisioning a game container within a cloud computing system is described. To begin, a game manifest may be accessed. The game manifest may include attributes corresponding to a game infrastructure role used by a game within a cloud computing system. A workflow definition is then generated based on the attributes of the game manifest. The workflow definition may specify an instance count for the game infrastructure role and a workflow activity. A group of infrastructural service nodes are then created in the cloud computing system, where the size of the group is based on based on the instance count. The infrastructural service nodes are then configured by executing the deployment action on each of the infrastructural service nodes.

### RELATED APPLICATION

This application claims the priority benefit of U.S. Provisional Application Ser. No. 61/784,585, entitled “METHODS AND SYSTEMS FOR PROVISIONING A GAME CONTAINER WITHIN A CLOUD COMPUTING SYSTEM,” filed Mar. 14, 2013, the disclosure of which is incorporated by reference herein in its entirety.

### TECHNICAL FIELD

The disclosed embodiments relate generally to techniques for provisioning a game container within a cloud computing system.

### BACKGROUND

Growth in computer networks has changed the uses of computers dramatically. The largest computer network, commonly known as the Internet or World Wide Web (“WWW”), is now connecting millions of computing devices in the world, providing services like e-mail, file transfer, and hypermedia information retrieval across different computer platforms. Increasingly, organizations such as companies, educational institutions, service providers and the like depend on networks that operate inside an organization and also connect to external networks such as the Internet.

With the rapid growth of network technology, many organizations have begun to utilize cloud-based computing systems to deploy web-based applications and services, such as online gaming systems, merchant stores, media outlets, and other on-line sites or services. Cloud computing is a type of computing that relies on sharing computing resources over a network (e.g., the Internet of an intranet) rather than having local, dedicated servers or personal devices to provide a web-based service.

Deploying online games in cloud-based system typically involves a manual process whereby a game developer individually interacts with one or more cloud systems to configure one or more physical or virtual resources to support the functions and services of a game. For example, the game developer may interact with a particular computational node in a cloud to install software packages on the computational node so that the computational node can operate as a web server. This configuration may be repeated individually any number of times with other computational nodes in the cloud until the game developer determines that the configured computational nodes can handle the web serving needs for the estimated user engagements. The game developer may then configure other needed functions for the game, such as caching and storage resources. It is to be appreciated that, similar to configuring the web servers, configuring these resources is likewise a manual process carried out by the game developer.

### BRIEF DESCRIPTION OF THE DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating an example of a gaming environment for implementing various example embodiments.

FIG. 2 is a block diagram illustrating a conceptual game container that may be deployed within a cloud computing system and otherwise configured by example embodiments.

FIG. 3 is a block diagram illustrating example modules and data flow for the game provisioning system of FIG. 1.

FIG. 4 is a data diagram of a game manifest, according to an example embodiment.

FIG. 5 is a flowchart of a method of provisioning a game container on a cloud computing system, according to an example embodiment.

FIG. 6 is a data diagram illustrating a game manifest that includes configuration attributes for different game environments for the same online game, according to an example embodiment.

FIG. 7 is a flowchart diagram illustrating a method of generating workflow definitions for multiple game environments, according to an example embodiment.

FIG. 8 illustrates an example data flow between example components of the example system of FIG. 1, according to some embodiments;

FIG. 9 illustrates an example network environment, in which various example embodiments may operate; and

FIG. 10 illustrates an example computing system architecture, which may be used to implement one or more of the methodologies described herein, according to some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

The embodiments described herein provide techniques for provisioning a game container within a cloud computing system. Generally a cloud computing system may include multiple computational nodes that may be configured to operate according to a game infrastructure role used by a game, such as a web front-end server, a caching layer, a persistent storage, a database server, a game logic server, a background job, or the like.

In an example embodiment, a computer-implemented method or system may access a game manifest to provision a game container with a cloud computing system. In some cases, the game manifest may be a file created by a game developer that models the architecture of a game being deployed. For example, the game manifest may specify attributes characterizing a game infrastructure role used by a game within a cloud system. An example of a game infrastructure role is a front-end web server, which may include properties that define a network address, game name, and the like. The computer-implemented method or system may then generate a workflow definition based on the attributes specified by the game manifest. The workflow definition may specify an instance count of the game infrastructure role and a workflow activity. The workflow activity may be an operation that may be performed with respect to a given computational node to configure that computational node as a game infrastructure role. The instance count may be used to determine how many computational nodes are to have the workflow activity be performed. The computer-implemented method or system may then configure a group of infrastructural nodes within the cloud computing system by executing the workflow activity on a group of nodes within the cloud computing system.

These and other embodiments of the invention are described in further detail below.

### Example System Architecture

FIG. 1 is a block diagram illustrating an example of a gaming environment 100 for implementing various example embodiments. In some embodiments, the gaming environment 100 comprises a user 102, a client device 104, a game system 106, a game provisioning system 108, and a network 120. The components of the gaming environment 100 may be connected directly or over the network 120, which may be any suitable network. Although FIG. 1 illustrates a particular example of the arrangement of the user 102, the client device 104, the game system 106, the game provisioning system 108, and the network 120, any suitable arrangement or configuration of the user 102, the client device 104, the game system 106, the game provisioning system 108, and the network 120 may be contemplated.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a online game. The client device 104 may access the gaming system 106 directly, via the network 120, or via a third-party system. For example, the client device 104 may access the game system 106 via a social networking system (e.g., FACEBOOK).

In some embodiments, the client device 104 may be communicatively coupled to or include an input device, such as a keyboard, a pointing device, and a display device (not shown). Such input devices may allow a user to interact with a game provided by the game system 106. For example, with the input devices, the client device 104 may allow a user to select (e.g., through a mouse click or a finger tap on a touch screen) a game object. Selecting a game object may cause the game system 106 to perform a game action on the selected game object.

With continued reference to FIG. 1, the game system 106 may include a network-addressable computing system (or systems) that can host one or more online games via one or more cloud systems, such as the cloud systems 110, 112. The game system 106, through the cloud systems 110, 112, may generate, store, receive, and transmit game-related data, such as, for example, game account data, game input, game state data, and game displays to the client device 104. The game system 106 may be accessed by the other components of the gaming environment 100 either directly or via the network 120. The user 102 may use the client device 104 to access, send data to, and receive data from the gaming system 106.

The cloud systems 110, 112 may operate a set of distributed computational (virtual or physical) resources that can be configured to host or otherwise provide functionality for an online game. Such computational resources may include a set of computer systems capable of being configured by the game provisioning system 108. For example, the cloud systems 110, 112 may include a configuration interface for installing and configuring operating systems, database management systems, hypervisors, web-servers, distributed cache systems, storage systems, web-service, administration servers, and the like. A piece of hardware (e.g., a computer server) registered within the cloud systems 110, 112 with a basic operating system and hypervisor may be referred to herein as a “computational node” of the cloud system.

Consistent with embodiments contemplated by this disclosure, the cloud systems 110, 112 may be operated by different entities. For example, the cloud system 110 may be operated by an entity associated with the hosted online game, while the cloud system 112 may be operated by a third party. Where the game provider operates the cloud system, the cloud system may be referred to as a private cloud. Where a third party operates the cloud system, the cloud system may be referred to as a public cloud. The ELASTIC COMPUTE CLOUD®, operated by and provided by AMAZON®, is an example of a public cloud.

The game provisioning system 108 may be a network-addressable computer system capable of provisioning a game container on the cloud system 110. As used herein, the term “game container” may refer to a deployment of a game on the cloud system 110. In example embodiments, a deployment of the game may involve configuring a set of computational nodes to each have a particular game infrastructure role within the game container. For example, each of the computational nodes may be configured (e.g., by installing software packages and setting configuration attributes) to provide commonly consumed functionality, such as a web front-end servers, a caching layer, a storage layer, background jobs, and the like. Such configurations may be specified using game manifests. Although described in greater detail below, a game manifest may generally be a file, record, or any other suitable organization of data that specifies game infrastructure roles and corresponding attributes for various game environments.

In various embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

FIG. 2 is a block diagram illustrating a conceptual game container 210 that may be deployed within a cloud computing system and otherwise configured by example embodiments. The conceptual game container 210 shown in FIG. 2 includes a set of game infrastructure roles. A game infrastructure role, as previously described above, may be a computational node with the cloud system that has been configured to provide a game functionality used by the hosted game. In some embodiments, configuring a computational node may include installing one or more software packages and applying configuration attributes according to configuration attributes specified in a game manifest (e.g., the game manifest 208 of FIG. 2).

FIG. 2 shows that the conceptual game container 210 may include web front-end servers 212, a caching layer 214, a storage layer 216, and one or more background jobs 218. The web front end servers 212 may be responsible for serving requests from the social networks and/or a game client operating on the client device 104. In some embodiments, the web front end servers 212 may be arranged in an array to provide scalable service.

The caching layer 214 may be a distributed cache for storing the game state. In some embodiments, the web front end servers 212 interact with the caching layer 214 to access game state. In addition to storing the game state, the caching layer 214 may also, according to some embodiments, store social networking data (e.g., an open graph), as may be obtained from a social networking site, such as FACEBOOK®.

The storage layer 216 may be durable storage for the game state. The storage layer may, in some embodiments, have a master-slave configuration for fault-tolerance.

The background jobs 218 may be a set of services that may be performed asynchronously in batch operations. For example, the background jobs 218 may perform such services as sending notifications to a friend's news-feed in FACEBOOK® or sending periodic email notifications to a set of users. A background job may have two subcomponents (not shown in FIG. 2): operational data and daemons. The operational data may be stored in the caching layer 214 which may then be periodically processed by the daemons.

With continued reference to FIG. 2, the conceptual game container 210 may be deployed on a cloud system 202. The cloud system 202 may be the cloud system 110 or the cloud system 112, or a combination thereof, as previously discussed with reference to FIG. 1. The cloud system 202 of FIG. 2 may include multiple game infrastructure roles 206a-n. As discussed above, a game infrastructure role may be a computational node that has been configured (e.g., installing software packages and configuration state) to provide gaming functions commonly utilized by online games. Accordingly, the game infrastructure roles 206a-n may have been configured to provide the functions of the web front-end servers 212, the caching layer 214, the storage 216, and the background jobs 218.

It is to be appreciated that the arrangement and structure of the conceptual game container 210 and the cloud system 202 shown in FIG. 2 are provided by way of example and not limitation. It is to be further appreciated that this disclosure includes any suitable arrangement or structure of the conceptual game container 210 and the cloud system 202. For example, other example embodiments, consistent with the embodiments contemplated by this disclosure, may include more or less components than shown in FIG. 2. In particular, one or more additional conceptual game containers may be deployed within the cloud system 202.

Deploying a game container on a cloud system may be performed by the game provisioning system 108, which is described in greater detail with reference to FIGS. 3-7.

FIG. 3 is a block diagram illustrating example modules and dataflow for the game provisioning system of FIG. 1. For example, the game provisioning system 108 may include a workflow builder 302 and a workflow engine 304. The workflow builder 302 may be a computer-implemented module that generates a workflow definition 310 from a game manifest 308. In general, the game manifest 308 may be meta-data describing a game architecture. Example game manifests are described in greater detail below with respect to FIG. 4. The generated workflow definition 310 may be data or logic that specifies a set of workflow operations that are to be executed on a computational node to configure a computational node as a game infrastructure role within a game container on the network gaming system 106.

FIG. 3 shows that the workflow engine 304 uses the workflow definition 310 to provision the game container within a cloud computing system 312. The cloud computing system 312 may be one or more of the cloud systems 110, 112 of the game system 106 shown in FIG. 1. In an example embodiment, provisioning the game container may include the workflow engine 304 executing a set of tasks on multiple computational nodes (e.g., computational nodes 306a-n), such as allocating computer resources, installing software packages, setting configuration values, and the like.

FIG. 4 is a data diagram of a game manifest 400, according to an example embodiment. In general, the game manifest 400 may be a file, or set of files, that includes data that describes an architecture model for a game container. For example, the game manifest 400 shown in FIG. 4 includes a game environment descriptor 402, role descriptors 404a-n, and a role setup descriptor 406. The game environment descriptor 402 may include configuration attributes that are common for or otherwise default for each of the game infrastructure roles that are being deployed for the online game. For example, the game environment descriptor 402 may include game attributes that specify a game name, a short name for the game, a cloud system to host the online game, security information (e.g., a security group, security keys, security policies, etc) used within the online game, a name of a storage system, an IP address for the load balancer of a game, the URL associated with the game, a number of users that will be supported for the game, and the like. In some embodiments, the game environment may include configuration attributes that are specific for a particular game environment (e.g., a production environment, a testing environment, a development environment, a staging environment, or any other suitable environment).

Each of the role descriptors 404a-n may specify a game infrastructure role that is to be deployed as part of the game container of an online game along with respective configuration attributes for the corresponding game infrastructure role. In an example embodiment, the role descriptor 404 may specify that that the game container may include a web front end server game infrastructure role. Other examples of game infrastructure roles that may be specified by the role descriptors 404a-n may include a caching layer, storage layer, or background jobs. Configuration attributes specified by the role descriptors 404a-n may be given priority over the same configuration attribute specified by the game environment descriptor 402. When a configuration attribute has priority over another configuration attribute, the configuration attribute with the higher priority overrides the value given to the lower priority attribute.

The role setup descriptor 406 may include, among other things, a configuration attribute referred to herein as an “instance count.” An instance count may specify a number of computational nodes that are to be configured as a game infrastructure role specified by a role descriptor. To illustrate a use of an instance count, a game manifest may include a role descriptor that includes configuration attributes specifying how a web front end server is to be configured. Additionally, the game manifest 400 may include a role setup descriptor 406 that, in turn, includes an instance count assigned to some number, say X, for a web front-end server. In such a case, the workflow builder 302 may generate a workflow definition that defines workflow activities for configuring a computational node as a web front-end server according to the configuration attributes specified in the role descriptor. Further, the workflow definition may specify that the workflow activities for configuring a computational node as a web front-end server according to the configuration attributes specified in the role descriptor is to be executed on X computational nodes.

FIG. 5 is a flowchart of a method 500 of provisioning a game container on a cloud computing system, according to an example embodiment. In some embodiments, the method 500 may be performed using any of the systems, components, modules shown in FIGS. 1-3 and, accordingly, is described by way of example with reference thereto.

The method 500 may begin at operation 502 when the workflow builder 302 accesses a game manifest. As described above, the game manifest may include, among other things, attributes that characterize a game infrastructure role used by a game container within a cloud computing system. Such attributes may include configuration attributes that specify software packages and configuration states of one or more game infrastructure roles for the online game. As described above, a game infrastructure role may provide functionality consumed by a game provided by the game container. A web front-end server, a caching layer, storage, background jobs are all examples of game infrastructure roles that provide functionality for an online game.

At operation 504, the workflow builder 302 may generate a workflow definition based on the attributes of the game manifest. The workflow definition may include, among other things, a workflow activity and an instance count of a game infrastructure role. The workflow activity may refer to an operation that is to be performed with respect to a computational node within the cloud system to configure the computational node into a game infrastructure role according to the configuration attribute specified by the game manifest. For example, the workflow activity may be a task that installs a software package identified in the game manifest, configures resources (e.g., memory cache, webserver listening port, etc.) of the computational node, connects or otherwise communicatively couples resources, or the like.

At operation 506, the workflow engine 304 may identify a group of computational nodes within the cloud system that are to be configured to serve as instances of the game infrastructure role specified by the game manifest. The size of the group of computational nodes may be determined based on the instance count specified by the game manifest. For example, the game manifest may include an instance count that specifies that X web front-end servers are to be deployed in the cloud computing system.

At operation 508, the workflow engine 204 may configure the identified group of computational nodes by causing the workflow activity to be executed on each computational node of the identified group of computational nodes. For example, in the case of a web front-end server, the workflow engine 204 may install a web server package on each of the computational nodes. For other game infrastructure roles, the workflow engine 204 may install PHP servers, database servers, and the like. For each of the workflow activities executed on the computational nodes, the game infrastructure role attributes specified in the game manifest may be used to specify attributes of the game infrastructure role. By way of example and not limitation, the workflow engine 204 may use an attribute specifying a listen port to configure the listen port of the web server installed on the computational node.

In some embodiments, based on data or logic in a game manifest, the provisioning system 108 to deploy multiple game containers configured for different game environments. For example, a game manifest may include one group of configuration attributes that specify one game environment (e.g., a staging environment) for the online game and another group of configuration attributes that specifies a different game environment (e.g., a production environment) for the same online game. In example embodiments, a game environment is used to specify a role for a game container. In some cases, different game environments are used to separate different codes sets so that the development activities occurring within one game environment does not interfere with another. Merely as an example, a “development environment” is used designate a game environment used to develop a game. Users (e.g., developers/administrators) in that game environment can expect the game to change often and be broken for extended periods of time. In comparison, a quality assurance (QA) game environment may be a game environment used to test the game. Those that are testing cannot have changes being made by developers during tests or the tests will be invalid. Further, a “staging game environment” may be used to test the game in a production environment without having users (e.g., outside players) access the game yet. The staging game environment may be used to ensure security settings are correct and that other services hosted in the cloud computation system do not interfere with the game. Still further, a “production game environment” may be a game environment where the users actually run the live game. Changes to the production game environment may be periodic updates to the game after the application changes have passed through the previous three game environments (e.g., the development game environment, the QA game environment, the staging game environment). The development game environment, the QA game environment, and the staging game environments help ensure that the game is well tested and stable when it is released.

FIG. 6 is a data diagram illustrating a game manifest 600 that includes configuration attributes for different game environments for the same online game, according to an example embodiment. For example, the game manifest 600 includes a default configuration attribute section 602, a staging environment section 604, and a production environment section 606.

The default configuration attribute section 602 may list default values for one or more configuration attributes that may be utilized for game infrastructure roles in various gaming environments. For example, the default configuration attribute section 602 includes a default value (“28M”) for the configuration attribute PHPMEMORYLIMIT (e.g., a limit on the memory a PHP server may utilize) for a game infrastructure role (e.g., a PHP server). It is to be appreciated that the game infrastructure roles and the configuration attributes listed in the default configuration attribute section 602, by themselves, do not cause the workflow builder 302 to generate a workflow definition for configuring a computational node as a game infrastructure role. Instead, the game infrastructure roles and the configuration attributes listed in the default configuration attribute section 602 define default values for configuration attributes in game environment sections specified within the game manifest 600.

For example, the staging environment section 604 may include configuration attributes for a “Web” game infrastructure role and a “PHP” game infrastructure role. Accordingly, the workflow builder 302 may generate a workflow that is operable to generate a game container using these game infrastructure roles and corresponding game attributes. Where a game infrastructure role does not provide a configuration value, the workflow builder 302 may utilize the configuration values specified in the default configuration attribute section 602. However, if a configuration attribute is supplied by both a game environment section and a default configuration attribute section, the workflow builder 302 will use the configuration attribute specified in the game environment section. Such is the case in FIG. 6 where the production environment section 606 includes a PHPMEMORYLIMIT (set to “26M”) configuration attribute, which overrides the PHPMEMORYLIMIT configuration attribute specified in the default configuration attribute section 602.

It is to be appreciated that the specific configuration attributes and game environment described with respect to the game manifest 600 of FIG. 6 are provided merely for the purpose of clarity of discussion and not limitation. Accordingly, other embodiments may use different, more, or less configuration attributes and game environments and still be consistent with embodiments contemplated by this disclosure.

FIG. 7 is a flowchart diagram illustrating a method 700 of generating workflow definitions for multiple game environments, according to an example embodiment. In some embodiments, the method 700 may be performed using any of the systems, components, modules shown in FIGS. 1-3 and, accordingly, is described by way of example with reference thereto.

The method 700 may begin at operation 702 when the workflow builder 302 obtains a default configuration attribute. For example, the workflow builder 302 may parse a game manifest file that includes a default configuration attribute section that lists one or more default values for configuration attributes within a game infrastructure role. See, e.g., the default configuration attribute section 602 shown in FIG. 6.

At operation 704 the workflow builder 302 may determine that a game environment is specified by a game environment section in the game manifest. A game environment section, according to some embodiments, may signify that a game container is to be generated separate from other game containers specified in other game environment sections. It is to be appreciated that in cases where the game manifest specifies multiple game environments, some embodiments may provide a comparatively convenient mechanism for administrators or game developers to define the configurations of particular game environments, such as a production environment, testing environment, development environment, or the like.

At decision 706, the workflow builder 302 may make a determination on whether the game environment section overrides a default configuration attribute specified in the default configuration attribute section of the game manifest. If the game environment section does override the default configuration attribute, the method 700 continues at operation 710; otherwise, the method 700 continues at operation 708.

At operation 708, the workflow builder 302 generates a workflow definition using the default configuration value specified in the default configuration attribute section of the game manifest file. For example, with momentary reference to FIG. 6, the workflow builder 302 may generate the workflow definition to deploy a game container corresponding to the staging game environment section 604 using the PHPMEMORY LIMIT configuration attribute specified in the default configuration attribute section 602. Such is the case because the staging game environment section 604 does not specify a configuration attribute for the PHPMEMORYLIMIT configuration attribute that was specified in the default configuration attribute section of the game manifest file.

With reference back to FIG. 7, at operation 710, the workflow builder 302 generates a workflow definition using the configuration attribute specified in the gaming environment section of the game manifest instead of the configuration attribute specified in the default configuration attribute section. For example, again with momentary reference to FIG. 6, workflow builder 302 may generate the workflow definition to deploy a game container corresponding to the staging game environment section 604 using the HTTPLISTENPORT configuration attribute specified in the staging game environment section 604 (e.g., “1234”) rather than the HTTPLISTENPORT configuration attribute specified in the default configuration attribute section 602 (e.g., “9000”).

At decision 712, the workflow builder 202 may determine whether the game manifest includes additional game environments. If the game manifest does include additional game environment sections, the workflow builder 302 then continues at operation 704, which is explained above. Otherwise, the method 700 terminates at operation 714. It is to be appreciated that continuing to operation 704, if the game manifest specifies additional game environments, may cause the workflow builder 302 to generate workflow activities associated with deploying a second game container, tailored according to configuration attributes associated with the additional game environment specified by the game manifest.

It is to be appreciated that example embodiments may provide a number of practical applications. For example, some example embodiments may provide a comparatively efficient mechanism to automatically deploy game containers into one or more cloud systems. Such may be the case because a game developer may use a game manifest to characterize the abstract architecture of the game system, such as memory usage, communication ports, game names, and the like, without necessarily configuring a number of computational nodes to support such features.

### Example Gaming Platforms

FIG. 8 illustrates an example data flow between example components of an example system 800. One or more of the components of the example system 800 may correspond to one or more of the components of the example gaming environment 100. In some embodiments, the system 800 includes a client system 830, a social networking system 820a, and a gaming platform 820b. The components of system 800 can be connected to each other in any suitable configuration, using any suitable type of connection. The components may be connected directly or over any suitable network. The client system 830, the social networking system 820a, and the gaming platform 820b may have one or more corresponding data stores such as local data store 825, social data store 845, and game data store 865, respectively.

The client system 830 may receive and transmit data 823 to and from the gaming platform 820b. This data can include, for example, a web page, a message, a game input, a game display, a HTTP packet, a data request, transaction information, and other suitable data. At some other time, or at the same time, the gaming platform 820b may communicate data 843, 847 (e.g., game state information, game system account information, page info, messages, data requests, updates) with other networking systems, such as the social networking system 820a (e.g., FACEBOOK, MYSPACE). The client system 830 can also receive and transmit data 827 to and from the social networking system 820a. This data can include, for example, web pages, messages, social graph information, social network displays, HTTP packets, data requests, transaction information, updates, and other suitable data.

Communication between the client system 830, the social networking system 820a, and the gaming platform 820b can occur over any appropriate electronic communication medium or network using any suitable communications protocols. For example, the client system 830, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming platform 820b, the BLOB containing the game state for the instance corresponding to the user may be transmitted to the client system 830 for use by a client-side executed object to process. In some embodiments, the client-side executable is a FLASH-based game, which can de-serialize the game state data in the BLOB. As a user plays the game, the game logic implemented at the client system 830 maintains and modifies the various game state parameters locally. The client-side game logic may also batch game events, such as mouse clicks, and transmit these events to the gaming platform 820b. Gaming platform 820b may itself operate by retrieving a copy of the BLOB from a database or an intermediate memory cache (memcache) layer. The gaming platform 820b can also de-serialize the BLOB to resolve the game state parameters and execute its own game logic based on the events in the batch file of events transmitted by the client to synchronize the game state on the server side. The gaming platform 820b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 830. For example, a client application downloaded to the client system 830 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages is associated with or accessed by the social networking system 820a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 830, either caused by an action of a game user or by the game logic itself, the client system 830 may need to inform the gaming platform 820b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game are represented as Adobe Flash objects. Flash may manipulate vector and raster graphics, and supports bidirectional streaming of audio and video. “Flash” may mean the authoring environment, the user, or the application files. In some embodiments, the client system 830 may include a Flash client. The Flash client may be configured to receive and run Flash application or game object code from any suitable networking system (such as, for example, the social networking system 820a or the gaming platform 820b). In some embodiments, the Flash client is run in a browser client executed on the client system 830. A user can interact with Flash objects using the client system 830 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 830, the Flash client may send the events that caused the game state changes to the in-game object to the gaming platform 820b. However, to expedite the processing and hence the speed of the overall gaming experience, the Flash client may collect a batch of some number of events or updates into a batch file. The number of events or updates may be determined by the Flash client dynamically or determined by the gaming platform 820b based on server loads or other factors. For example, client system 830 may send a batch file to the gaming platform 820b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 830, the gaming platform 820b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming platform 820b may retrieve the corresponding BLOB from the database to determine the most-recent values of the game-related data. In some embodiments, while a user is playing the virtual game, the gaming platform 820b also loads the corresponding BLOB into a memory cache so that the game system may have faster access to the BLOB and the game-related data contained therein.

Various embodiments may operate in a wide area network environment, such as the Internet, including multiple network addressable systems. FIG. 9 illustrates an example network environment 900, in which various example embodiments may operate. Network cloud 960 generally represents one or more interconnected networks, over which the systems and hosts described herein can communicate. The network cloud 960 may include packet-based wide area networks (such as the Internet), private networks, wireless networks, satellite networks, cellular networks, paging networks, and the like. As FIG. 9 illustrates, various embodiments may operate in a network environment 900 comprising one or more networking systems, such as a social networking system 920a, a gaming platform 920b, and one or more client systems 930. The components of the social networking system 920a and the gaming platform 920b operate analogously; as such, hereinafter they may be referred to simply as the networking system 920. The client systems 930 are operably connected to the network environment 900 via a network service provider, a wireless carrier, or any other suitable means.

The networking system 920 is a network addressable system that, in various example embodiments, comprises one or more physical servers 922 and data stores 924. The one or more physical servers 922 are operably connected to the computer network cloud 960 via, by way of example, a set of routers and/or networking switches 926. In an example embodiment, the functionality hosted by the one or more physical servers 922 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 922 may host functionality directed to the operations of the networking system 920. Hereinafter, the physical servers 922 may be referred to as server 922, although the server 922 may include numerous servers hosting, for example, the networking system 920, as well as other content distribution servers, data stores, and databases. The data store 924 may store content and data relating to, and enabling, operation of, the networking system 920 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, the data store 924 corresponds to one or more of a variety of separate and integrated databases, such as relational databases and object-oriented databases that maintain information as an integrated collection of logically related records or files stored on one or more physical systems. Structurally, the data store 924 may generally include one or more of a large class of data storage and management systems. In some embodiments, the data store 924 may be implemented by any suitable physical system(s) including components, such as one or more database servers, mass storage media, media library systems, storage area networks, data storage clouds, and the like. In one example embodiment, the data store 924 includes one or more servers, databases (e.g., MySQL), and/or data warehouses. Data store 924 may include data associated with different networking system 920 users and/or client systems 930.

The client system 930 is generally a computer or computing device including functionality for communicating (e.g., remotely) over a computer network. The client system 930 may be a desktop computer, laptop computer, personal digital assistant (PDA), in- or out-of-car navigation system, smart phone or other cellular or mobile phone, or mobile gaming device, among other suitable computing devices. The client system 930 may execute one or more client applications, such as a Web browser.

When a user at the client system 930 desires to view a particular webpage (hereinafter also referred to as target structured document) hosted by the networking system 920, the user's web browser, or other document rendering engine or suitable client application, formulates and transmits a request to the networking system 920. The request generally includes a URL or other document identifier as well as metadata or other information. By way of example, the request may include information identifying the user, a timestamp identifying when the request was transmitted, and/or location information identifying a geographic location of the user's client system 930 or a logical network location of the user's client system 930.

Although the example network environment 900 described above and illustrated in FIG. 9 is described with respect to the social networking system 920a and the gaming platform 920b, this disclosure encompasses any suitable network environment using any suitable systems. For example, a network environment may include online media systems, online reviewing systems, online search engines, online advertising systems, or any combination of two or more such systems.

FIG. 10 illustrates an example computing system architecture, which may be used to implement a server 1022 or a client system 1030. In one embodiment, the hardware system 1000 comprises a processor 1002, a cache memory 1004, and one or more executable modules and drivers, stored on a tangible computer-readable storage medium, directed to the functions described herein. Additionally, the hardware system 1000 may include a high performance input/output (I/O) bus 1006 and a standard I/O bus 1008. A host bridge 1010 may couple the processor 1002 to the high performance I/O bus 1006, whereas the I/O bus bridge 1012 couples the two buses 1006 and 1008 to each other. A system memory 1014 and one or more network/communication interfaces 1016 may couple to the bus 1006. The hardware system 1000 may further include video memory (not shown) and a display device coupled to the video memory. Mass storage 1018 and I/O ports 1020 may couple to the bus 1008. The hardware system 1000 may optionally include a keyboard, a pointing device, and a display device (not shown) coupled to the bus 1008. Collectively, these elements are intended to represent a broad category of computer hardware systems.

The elements of the hardware system 1000 are described in greater detail below. In particular, the network interface 1016 provides communication between the hardware system 1000 and any of a wide range of networks, such as an Ethernet (e.g., IEEE 802.3) network, a backplane, etc. The mass storage 1018 provides permanent storage for the data and programming instructions to perform the above-described functions implemented in servers 1022 of FIG. 8, whereas system memory 1014 (e.g., DRAM) provides temporary storage for the data and programming instructions when executed by the processor 1002. I/O ports 1020 are one or more serial and/or parallel communication ports that provide communication between additional peripheral devices, which may be coupled to the hardware system 1000.

The hardware system 1000 may include a variety of system architectures and various components of the hardware system 1000 may be rearranged. For example, cache memory 1004 may be on-chip with the processor 1002. Alternatively, the cache memory 1004 and the processor 1002 may be packed together as a “processor module,” with processor 1002 being referred to as the “processor core.” Furthermore, certain embodiments of the present disclosure may neither require nor include all of the above components. For example, the peripheral devices shown coupled to the standard I/O bus 1008 may couple to the high performance I/O bus 1006. In addition, in some embodiments, only a single bus may exist, with the components of the hardware system 1000 being coupled to the single bus. Furthermore, the hardware system 1000 may include additional components, such as additional processors, storage devices, or memories.

An operating system manages and controls the operation of the hardware system 1000, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. For example, certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the hardware system 1000) or one or more hardware modules of a computer system (e.g., the processor 1002 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1002 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise the processor 1002 configured using software, the processor 1002 may be configured as respective different hardware modules at different times. Software may accordingly configure a processor 1002, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1002 that are temporarily configured (e.g., by software, code, and/or instructions stored in a machine-readable medium) or permanently configured to perform the relevant operations. Whether temporarily or permanently configured, such processors 1002 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1002 or processor-implemented (or computer-implemented) modules. Similarly, at least some of the operations of a method may be governed by instructions that are stored in a computer readable storage medium and executed by one or more processors 1002 or processor-implemented (or computer-implemented) modules. The performance of certain of the operations may be distributed among the one or more processors 1002, not only residing within a single machine, but deployed across a number of machines. In some example embodiments, the processors 1002 may be located in a single location (e.g., within a home environment, an office environment or as a server farm), while in other embodiments the processors 1002 may be distributed across a number of locations.

While the embodiment(s) is (are) described with reference to various implementations and exploitations, it will be understood that these embodiments are illustrative and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A computer-implemented method, comprising:
accessing a game manifest, the game manifest including attributes characterizing a game infrastructure role used by a game hosted within a cloud computing system, the cloud computing system includes a plurality of computational nodes;
generating, by one or more processors, a workflow definition based on the attributes of the game manifest, the workflow definition specifying an instance count of the game infrastructure role and a workflow activity;
identifying a group of computational nodes from the plurality of computational nodes, the group of computational nodes having a size based on the instance count; and
configuring the group of computational nodes by executing the workflow activity on each computational node from the group of computational nodes.

2. The computer-implemented method of claim 1, wherein the attributes specify at least one of a software package or configuration state for the game infrastructure role.

3. The computer-implemented method of claim 1, wherein the game infrastructure role is at least one of: a web front-end server, a caching layer, a persistent storage, a database server, a game logic server, or a background job.

4. The computer-implemented method of claim 1, wherein a default attribute is specified in a default configuration attribute section of the game manifest.

5. The computer-implemented method of claim 4, further comprising:
determining that a work environment section lacks a work environment specific attribute that overrides the default attribute specified in the default configuration attribute section; and
generating the workflow definition based default attribute specified in the default configuration attribute section.

6. The computer-implemented method of claim 4, further comprising:
determining that a work environment section specifies a work environment specific attribute that overrides the default attribute specified in the default configuration attribute section; and
generating the workflow definition based on the work environment specific attribute specified in the work environment section.

7. The computer-implemented method of claim 6, wherein the work environment section represents at least one of: a staging game environment, a production game environment, a development environment, or a quality assurance environment.

8. A computer-implemented system, comprising:
a workflow builder implemented by one or more processors and configured to:
access a game manifest, the game manifest including attributes characterizing a game infrastructure role used by a game hosted within a cloud computing system, the cloud computing system includes a plurality of computational nodes, and
generate, by one or more processors, a workflow definition based on the attributes of the game manifest, the workflow definition specifying an instance count of the game infrastructure role and a workflow activity; and
a workflow builder implemented by one or more processors and configured to:
identify a group of computational nodes from the plurality of computational nodes, the group of computational nodes having a size based on the instance count, and
configure the group of computational nodes by executing the workflow activity on each computational node from the group of computational nodes.

9. The computer-implemented system of claim 8, wherein the attributes specify at least one of a software package or configuration state for the game infrastructure role.

10. The computer-implemented system of claim 8, wherein the game infrastructure role is at least one of: a web front-end server, a caching layer, a persistent storage, a database server, a game logic server, or a background job.

11. The computer-implemented system of claim 8, wherein a default attribute is specified in a default configuration attribute section of the game manifest.

12. The computer-implemented system of claim 11, wherein the workflow builder is further configured to:
determine that a work environment section lacks a work environment specific attribute that overrides the default attribute specified in the default configuration attribute section; and
generate the workflow definition based default attribute specified in the default configuration attribute section.

13. The computer-implemented system of claim 11, wherein the workflow builder is further configured to:
determine that a work environment section specifies a work environment specific attribute that overrides the default attribute specified in the default configuration attribute section; and
generate the workflow definition based on the work environment specific attribute specified in the work environment section.

14. The computer-implemented system of claim 13, wherein the work environment section represents at least one of: a staging game environment, a production game environment, a development environment, or a quality assurance environment.

15. A non-transitory computer-readable medium storing executable instructions thereon, which, when executed by a processor, cause the processor to perform operations comprising:
accessing a game manifest, the game manifest including attributes characterizing a game infrastructure role used by a game hosted within a cloud computing system, the cloud computing system includes a plurality of computational nodes;
generating, by one or more processors, a workflow definition based on the attributes of the game manifest, the workflow definition specifying an instance count of the game infrastructure role and a workflow activity;
identifying a group of computational nodes from the plurality of computational nodes, the group of computational nodes having a size based on the instance count; and
configuring the group of computational nodes by executing the workflow activity on each computational node from the group of computational nodes.

16. The non-transitory computer-readable medium of claim 15, wherein the attributes specify at least one of a software package or configuration state for the game infrastructure role.

17. The non-transitory computer-readable medium of claim 15, wherein the game infrastructure role is at least one of: a web front-end server, a caching layer, a persistent storage, a database server, a game logic server, or a background job.

18. The non-transitory computer-readable medium of claim 15, wherein a default attribute is specified in a default configuration attribute section of the game manifest.

19. The non-transitory computer-readable medium of claim 18, wherein the operations further comprises:
determining that a work environment section lacks a work environment specific attribute that overrides the default attribute specified in the default configuration attribute section; and
generating the workflow definition based default attribute specified in the default configuration attribute section.

20. The non-transitory computer-readable medium of claim 18, wherein the operations further comprises:
determining that a work environment section specifies a work environment specific attribute that overrides the default attribute specified in the default configuration attribute section; and
generating the workflow definition based on the work environment specific attribute specified in the work environment section.
